(19) United States
(12) Patent Application Publication
(10) Pub. No.: US 2014/0333820 A1
(43) Pub. Date: Nov. 13, 2014

(54) Polarizing Optical Element, Optical Low Pass Filer and Photographing Apparatus

(71) Applicant: RICOH IMAGING COMPANY, LTD., TOKYO (JP)

(72) Inventor: Hideo FUJII, Saitama (JP)

(73) Assignee: RICOH IMAGING COMPANY, LTD., TOKYO (JP)

(21) Appl. No.: 14/268,043

(22) Filed: May 2, 2014

(30) Foreign Application Priority Data
May 8, 2013 (JP) 2013-098199

(51) Int. Cl. H04N 5/225; G02B 1/11; G02B 1/10; G02B 5/30

(52) U.S. Cl. CPC H04N 5/2254; G02B 5/305; G02B 1/111; G02B 1/105
USPC 348/342; 359/488.01; 428/216

(57) ABSTRACT

A polarizing optical element comprising a multdayer film in which two or more types of polymeric films are laminated, wherein a number of laminated polymeric films is 500 to 500,000 in total, each of the two or more types of polymeric films has a uniform refractive index and has a film thickness of 0.2 μm to 40 μm, and a difference in refractive index between the two or more types of polymeric films is larger than or equal to 0.05.

### BACKGROUND OF THE INVENTION

The present invention relates to a polarizing optical element, an optical low pass filter and a photographing apparatus in which the optical low pass filter is provided.

When nonpolarized light is incident on an anisotropy crystal, such as calcite (CaCO₃), crystal (SiO₂), sapphire (Al₂O₃), rutile (TiO₂) and lithium niobate (LiNbO₃), the incident light is split into an ordinary ray and an extraordinary ray due to birefringence of a crystal substance. As an optical element which utilizes birefringence, a polarizing optical element and an optical low pass filter are known. For example, an optical low pass filter is employed in a photographing apparatus, such as, a digital still camera, capable of photographing a subject. The optical low pass filter is disposed between an imaging optical system and a solid state imaging device, and eliminates a high frequency component which is finer than a pixel pitch by splitting light which has passed the imaging optical system. As a result, occurrence of moire and a false signal can be suppressed. Japanese Patent Provisional Publication No. 2002-122813A (hereafter, referred to as patent document 1) describes a concrete configuration of an optical low pass filter of this type.

There are various types of polarizing optical elements and optical low pass filters other than the type described in patent document 1. For example, Japanese Examined Patent Application Publication No. S61-16961B (hereafter, referred to as patent document 2) describes a polarizing optical element configured to absorb polarized light by scattering metal in a dielectric medium, and describes a polarizing optical element which achieves polarization of light through loss of light amount caused by a metal film in a laminated body where dielectric films and metal films are laminated. Japanese Patent Provisional Publication No. 2004-138807A (hereafter, referred to as patent document 3) describes an optical low pass filter of a type where an optically anisotropic polymeric material is cut out obliquely.

### SUMMARY OF THE INVENTION

However, regarding the optical low pass filter described in patent document, there is a problem that it is difficult to grow a crystal substance to have a large size and it is also difficult to increase the area of the crystal substance. Such difficulty in manufacturing an optical low pass filter of the type described in patent document 1 raises a problem that manufacturing cost of the optical low pass filter is high. In addition, a polarizing optical element of the type in which metal is scattered as described in patent document 2 has a large degree of wavelength dependence because the polarizing optical element is configured to absorb one polarizing component. Therefore, it is not easy to manufacture such a polarizing optical element because it is necessary to precisely set manufacturing conditions in accordance with a desired wavelength band on a case-by-case basis. Furthermore, regarding the polarizing optical element of the type in which dielectric films and metal films are laminated as described in patent document 2, the number of films which can be laminated is low, and therefore it is difficult to increase the size of the polarizing optical element. Furthermore, since the optical low pass filter described in patent document 3 is configured to achieve optical anisotropy by extending an optically isotropic polymeric material in one axis direction, there is a problem that control of a refractive index is difficult and dispersion in anisotropy becomes easy to occur.

The present invention is advantageous in that it provides an polarizing optical element, an optical low pass filter and a photographing apparatus which are inexpensive and easy to manufacture and which are suitably configured to increase the area thereof and a photographing apparatus in which such an optical low pass filter is provided.

According to an aspect of the invention, there is provided a polarizing optical element comprising a multilayer film in which two or more types of polymeric films are laminated. In this configuration, the number of laminated polymeric films is 500 to 500,000 in total, each of the two or more types of polymeric films has a uniform refractive index and has a film thickness of 0.2 μm to 40 μm, and a difference in refractive index between the two or more types of polymeric films is larger than or equal to 0.05.

According to the above described configuration, the polarizing optical element can be obtained by simply laminating the polymeric films to make a multilayer film without subjecting the polymeric films to a special processing such as a drawing processing. Since the manufacturing process is simple, the polarizing optical element can be easily manufactured and the manufacturing cost can be reduced. Furthermore, it is possible to easily design and manufacture the polarizing optical element in a wide size range (from a small polarizing optical element to a large polarizing optical element) by arbitrary setting the size in a surface direction, the size in a thickness direction and the number of lamination layers of the polymeric films.

The two or more types of polymeric films may comprise a first polymeric film and a second polymeric film. In this case, the first polymeric film may have a refractive index of 1.56 to 2.5, and the second polymeric film may have a refractive index of 1.34 to 1.55.

the first polymeric film may be one of polyester, polycarbonate, and high refractive index ultraviolet curing resin, and the second polymeric film may be one of amorphous polyolefin, polymethyl methacrylate, fluororesin, and low refractive index ultraviolet curing resin.

A surface of the polarizing optical element may be provided with one of an antireflection coating, an antistatic coating, a water repellent film, an oil repellent film and a diffraction structure.

According to another aspect of the invention, there is provided with an optical low pass filter comprising a polarizing beam splitter obtained as a flat plate member cut out from one of the above described polarizing optical element. The flat plate member is cut out from the polarizing optical element to have a predetermined angle with respect to an optical axis of the polarizing optical element.

According to another aspect of the invention, there is provided with a photographing apparatus, comprising: an imaging optical system; the above described optical low pass filter, wherein the optical low pass filter splits a light ray passed through the imaging optical system into a plurality of light rays in a predetermined direction and at a predetermined splitting width; and; and a solid state imaging device on which the plurality of light rays split by the optical low pass filter incident. The plurality of light rays split by the optical low pass filter are incident on different neighboring pixels arranged on the solid state imaging device.

### BRIEF DESCRIPTION OF THE ACCOMPANYING DRAWINGS

FIG. 1 is a cross sectional view of a polarizing optical element according to an embodiment of the invention.

FIG. 2 is an explanatory illustration for explaining a processing example of a polarizing beam splitter according to the embodiment.

FIG. 3 is a perspective view of the polarizing beam splitter according to the embodiment of the invention.

FIG. 4 is a block diagram illustrating a configuration of a photographing apparatus in which the optical low pass filter according to the embodiment of the invention is installed.

FIG. 5 schematically illustrates a configuration of the optical low pass filter according to the embodiment of the invention.

FIG. 6 is a graph illustrating the spectral reflectance of an entrance surface and an exit surface of the polarizing beam splitter before and after a plasma etching process.

### DETAILED DESCRIPTION OF THE EMBODIMENTS

Hereinafter, a polarizing optical element, an optical low pass filter and a photographing apparatus according to an embodiment of the invention are described with reference to the accompanying drawings.

Configuration of Polarizing Optical Element 300

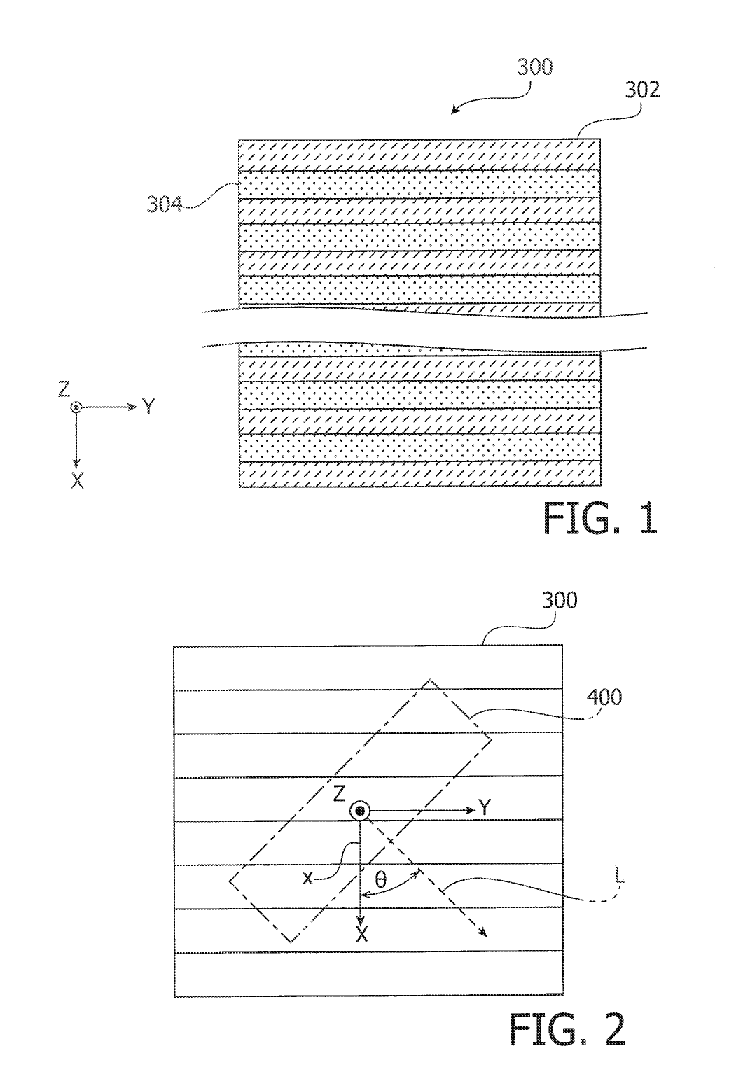

FIG. 1 is a cross sectional view of a polarizing optical element 300 according to the embodiment of the invention. As shown in FIG. 1, the polarizing optical element 300 is a multilayer film in which first polymeric films 302 and second polymeric films 304 are alternately laminated. In FIG. 1, a direction in which the first polymeric films 302 and the second polymeric films 304 are laminated is defined as X-axis direction, and two directions which are perpendicular to X-axis direction and perpendicularly intersect with each other are defined as Y-axis direction (which is parallel with a paper face of FIG. 1) and Z-axis direction (which is orthogonal to the paper face of FIG. 1), respectively.

The first polymeric film 302 is a polymeric film which has refractive index-isotropy (i.e., a uniform refractive index), has the film thickness of 0.2 μm to 40 μm and has the refractive index of 1.56 to 2.5. The second polymeric film 304 is a polymeric film which has refractive index-isotropy (i.e., a uniform refractive index), has the film thickness of 0.2 μm to 40 μm and has the refractive index of 1.34 to 1.55. Conditions for combining the first polymeric film 302 and second polymeric film 304 are as follows. Specifically, materials of the first polymeric film 302 and the second polymeric film 304 are selected such that the difference in refractive index between the first polymeric film 302 and the second polymeric film 304 becomes larger than or equal to 0.05. The first polymeric film 302 is, for example, polyester, polycarbonate, high refractive index ultraviolet curing resin. The second polymeric film 304 is, for example, amorphous polyolefin, polymethyl methacrylate, fluororesin, or low refractive index ultraviolet curing resin. The tonal lamination number of the first polymeric films 302 and the second polymeric films 304 are 500 to 500,000. These polymeric films are bonded through thermocompression bonding, adhesion or the like.

As shown in FIG. 1, the polarizing optical element 300 is configured to be a structural birefringent body in which two types of dielectric substances having different refractive indexes (i.e., the first polymeric film 302 and the second polymeric film 304) are regularly arranged in X-axis direction at an interval of 0.2 μm to 40 μm. Therefore, the polarizing optical element 300 can be regarded as a uniaxial crystal substance formed of an anisotropy crystal substance. More specifically, light which has entered the polarizing optical element 300 in X-axis direction has no difference in normal velocities in regard to every oscillation direction. Therefore, the polarizing optical element 300 can be regarded as having an optical axis x in a direction parallel with X-axis direction.

Let us consider a case where light propagates through the polarizing optical element 300 in Z-axis direction. In this case, light oscillating in Y-axis direction corresponds to an ordinary ray and light oscillating in X-axis direction corresponds to an extraordinary ray. When the refractive index and the physical film thickness of the first polymeric film 302 are defined as n_{H}, d_{H}, respectively, the refractive index of the second polymeric film 304 is defined as n_{L} which is lower than n_{H}, and the physical film thickness of the second polymeric film 304 is defined as d_{L}, a refractive index n_{O} of the ordinary ray and a refractive index n_{E} of the extraordinary ray are approximately expressed by the following expressions.

n_{O}=(n_{H}⁻²d_{H}/(d_{H}+d_{L})+n_{L}⁻²d_{L}/(d_{H}+d_{L}))^{-1/2}

n_{E}=(n_{H}²d_{H}/(d_{H}+d_{L})+n_{L}²d_{L}/(d_{H}+d_{L}))^{1/2}

According to the embodiment, the polarizing optical element 300 can be obtained by simply laminating and bonding the first polymeric films 302 and the second polymeric films 304 through thermocompression bonding, adhesion or the like without subjecting the first polymeric films 302 and the second polymeric films 304 to a special processing such as a. drawing processing. Since, according to the embodiment, the manufacturing process is thus simplified, the polarizing optical element 300 can be easily manufactured and the manufacturing cost can be reduced. Furthermore, it is possible to easily design and manufacture the polarizing optical element 300 in a wide size range (from a small polarizing optical element to a large polarizing optical element) by arbitrary setting the size in a surface direction, the size in a thickness direction and the number of lamination layers of the first polymeric films 302 and the second polymeric films 304.

Hereafter, four concrete design examples (1^{st} to 4^{th} examples) of the polarizing optical element 300 are explained.

### 1^{st} Example

The polarizing optical element 300 according to the 1^{st} example is configured by alternately laminating 50,000 first polymeric films 302 and 50,000 second polymeric films 304 (100,000 polymeric films in total), heating the laminated films to the deflection temperature under load of a polycarbonate, film of 160° C., and bonding the laminated films through thermocompression bonding. As a result, the polarizing optical element 300 having the thickness of 40 mm is obtained. In the 1^{st} example, the refractive index n_{O} of the ordinary ray is 1.472 and the refractive index n_{E} of the extraordinary ray is 1.486.

(First Polymeric Films 302)

Material: polycarbonate

Refractive Index: 1.585

Film Thickness: 0.4 μm

(Second Polymeric Films 304)

Material: fluororesin

Refractive Index: 1.380

Film Thickness: 0.4 μm

### 2^{nd} Example

The polarizing optical element 300 according to the 2^{nd} example is configured by alternately laminating 50,000 first polymeric films 302 and 50,000 second polymeric films 304 (100,000 polymeric films in total), heating the laminated films to the deflection temperature under load of an amorphous polyolefin film of 140° C., and bonding the laminated films through thermocompression bonding. As a result, the polarizing optical element 300 having the thickness of 40 mm is obtained. In the 2^{nd} example, the refractive index n_{O} of the ordinary ray is 1.571 and the refractive index n_{F} of the extraordinary ray is 1.573.

(First Polymeric Films 302)

Material: polyester

Refractive Index: 1.607

Film Thickness: 0.4 μm

(Second Polymeric Films 304)

Material: amorphous polyolefin

Refractive Index: 1.530

Film Thickness: 0.4 μm

### 3^{rd} Example

The polarizing optical element 300 according to the 3^{rd} example is configured by alternately laminating 50,000 first polymeric films 302 and 50,000 second polymeric films 304 (100,000 polymeric films in total), heating the laminated films to the deflection temperature under load of a polymethyl methacrylate film of 90° C., and bonding the laminated films through thermocompression bonding. As a result, the polarizing optical element 300 having the thickness of 40 mm is obtained. In the 3^{rd} example, the refractive index n_{O} of the ordinary ray is 1.545 and the refractive index n_{E} of the extraordinary ray is 1.550.

(First Polymeric Films 302)

Material: polyester

Refractive index: 1.607

Film Thickness: 0.4 μm

(Second Polymeric Films 304)

Material: polymethyl methacrylate

Refractive Index: 1.490

Film Thickness: 0.4 μm

### 4^{th} Example

In the 4^{th} example, as ultraviolet curing resin forming the first polymeric film 302, hard coat agent “LIODURAS” TYZ series (the refractive index of 1.690) provided by TOYO INK CO., LTD. is selected, and as ultraviolet curing resin thrilling the second polymeric film 304, hard coat agent “LIODURAS” LCH series (the refractive index of 1.520) provided by TOYO INK CO., LTD. is selected. The selected two types of ultraviolet curing resin are alternately coated in 50,000 layers (the total number of layers is 100,000) and in a film thickness of 0.4 μm on a glass plate having the thickness of 2 mm (S-BSL7 provided by OHARA, INC.) through dip coating. By removing, from the glass plate, multilayer sheets laminated on the both sides of the glass plate, two sheets of polarizing optical elements 300 having the thickness of 40 mm are obtained. In the 4^{th} example, the refractive index n_{O} of the ordinary ray is 1.598 and the refractive index n_{E} of the extraordinary ray is 1.607. Coating conditions for the two types of ultraviolet curing resin are indicated below.

(Coating Condition for TYZ Series)

After dipping the glass plate in a coating solution adjusted by methyl isobutyl ketone for 20 seconds, the glass plate is pulled up at the rate of 240 mm/minute, is dried for one minute at 100° C., and is subjected to ultraviolet radiation of 85 mJ/cm².

(Coating Condition for LCH Series)

After dipping the glass plate in a coating solution adjusted by methyl isobutyl ketone for 20 seconds, the glass plate is pulled up at the rate off 240 mm/minute, is dried for 30 seconds at 80° C., and is subjected to ultraviolet radiation of 85 ml/cm².

Example of Processing of Polarizing Beam Splitter 400

Hereafter, an example of processing for converting the polarizing optical element 300 to a polarizing beam splitter 400 is explained. Here, let us pick up the polarizing optical element 300 according to the 3^{rd} example as an example, and explanation is given with reference to FIG. 2. As shown in FIG. 2, in the polarizing optical element 300, a splitting width δ between the ordinary ray and the extraordinary ray becomes maximum when the angle θ of the optical axis x with respect to the incident light L is 45°. Therefore, in this example, a flat plate formed to be perpendicular to the incident light L (light proceeding in a direction forming the angle of 45° with respect to the optical axis x) is cut out from the polarizing optical element 300. In other words, a flat plate is cut out from the polarizing optical element 300 such that each of an entrance surface and an exit surface of the flat plate forms the angle of 45° with respect to a film boundary. As a result, the polarizing beam splitter 400 (the cut out flat plate) having a large splitting width δ can be obtained.

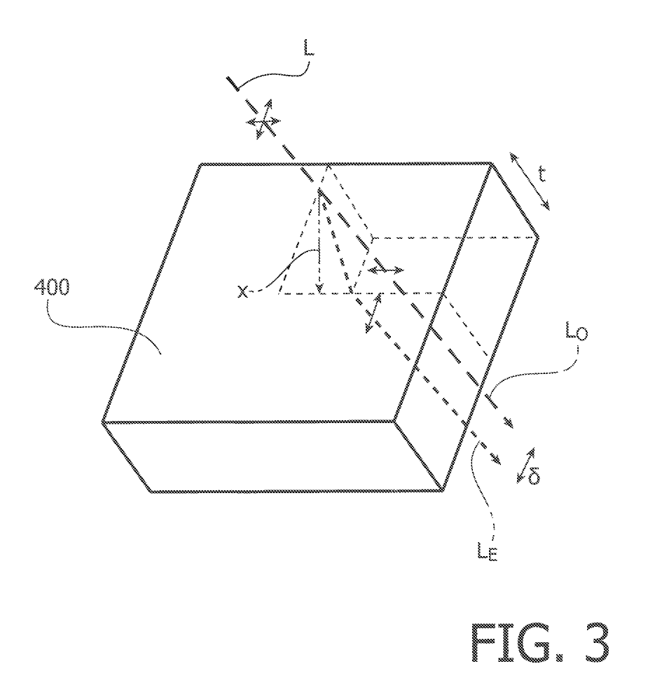

FIG. 3 is a perspective view of the polarizing beam splitter 400. As shown in FIG. 3, the polarizing beam splitter 400 is disposed such that the optical axis x forms the angle of 45° with respect to a direction (a direction perpendicular to the entrance surface of the polarizing beam splitter 400) in which the incident light L enters thereto. Therefore, when the incident light L enters the polarizing beam splitter 400, the incident light L is split into the ordinary ray L_{O} and the extraordinary ray L_{E}. The splitting width δ is represented by the following expression when the thickness of the polarizing beam splitter 400 in the direction in which the incident light L enters thereto is defined as t.

δ=(n_{E}²−n_{O}²)×t/(2n_{O})

Configuration of Photographing Apparatus 1

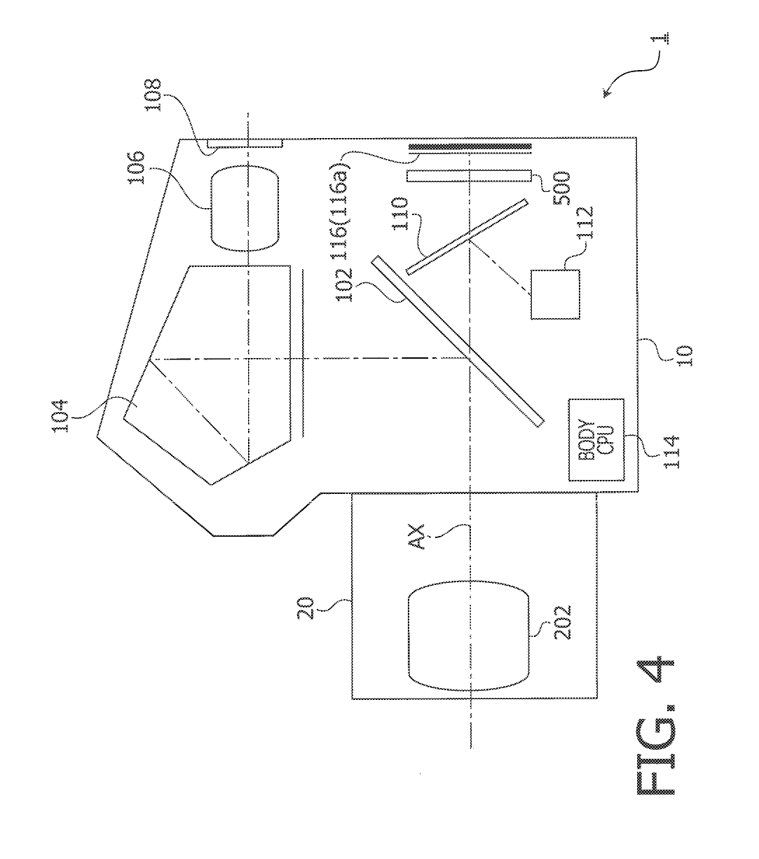

Hereafter, an example in which the polarizing beam splitter 400 is used as an optical low pass filter 500 for a photographing apparatus is explained. FIG. 4 is a block diagram illustrating a configuration of a photographing apparatus 1 which the optical tow pass filter 500 is installed. The photographing apparatus 1 in this example is, for example, a digital single reflex camera (having a quick return mirror); however, the photographing apparatus 1 may be a mirror-less single reflex camera, a compact digital camera, a camcorder, a mobile phone, a PHS (Personal Handy phone System), a smart phone, a feature phone or a portable game machine, which has the photographing function.

As shown in FIG. 4, the photographing apparatus 1 includes a camera body 10 and an interchangeable lens 20 which is interchangeable and is detachably attachable to the camera body 10. The light beam from a subject (a subject light beam) passes through an imaging lens (an imaging optical system) 202 in the interchangeable lens 20, and is reflected by a main mirror 102 in the camera body 10 toward a pentaprism 104. The subject light beam is formed as an erect image by being reflected by reflection surfaces of the pentaprism 104, and is incident on an eyepiece lens 106. The subject light beam is converged again by the eyepieces lens 106 as a virtual image which is suitable for observation by a photographer. The photographer is able to observe the subject image (the virtual image) converged again by the eyepiece lens 106 by viewing the subject image through a finder 108.

A part of the main mirror 102 is formed as a half mirror area. Therefore, a part of the subject light beam passes through the main mirror 102 (the half mirror area), and is reflected downward by a sub mirror 110 provided on a rear side of the main mirror 102. Then, the part of the subject light beam is incident on an automatic focus detection module 112. The automatic focus detection module 112 detects a focusing state of the subject, and outputs a signal corresponding to the detection result to a body CPU (Central Processing Unit) 114. The body CPU 114 executes defocus calculation based on the signal inputted from the automatic focus detection module 112, and performs focus adjustment of the imaging lens 202 based on a defocus amount obtained through the defocus calculation. In FIG. 4, electric wiring between the blocks is omitted for the sake of simplicity.

When a release switch (not shown) is pressed, the body CPU 114 causes the main mirror 102 to make a quick return motion. That is, the body CPU 114 causes the main mirror 102 to retract from an optical path which is parallel with an optical axis AX of the imaging lens 202, by lifting up the main mirror 102 only in a time period immediately before start of running of a front curtain of a focal plane shutter (not shown) and immediately after end of running of a rear curtain of the focal plane shutter. Since the sub mirror 110 is configured to move mechanically in conjunction with the main mirror 102, the sub mirror 110 also retracts from the optical path together with mirror up of the main mirror 102.

On the rear side of the sub mirror 110, the optical low pass filter 500 and an image sensor 116 are provided. Therefore, the subject light beam which has passed through the imaging lens 202 is split by the optic low pass filter 500, and is converged onto an imaging surface 116a of the image sensor 116. The image sensor 116 is, for example, a CCD (Charge Coupled Device) image sensor or a CMOS (Complementary Metal Oxide Semiconductor) image sensor, and is configured to accumulate charges corresponding to the light amount of an optical image formed at each pixel on the imaging surface 116a, and converts the accumulated charges into an imaging signal. The converted imaging signal is processed by an image processing circuit (not shown) so as to be displayed on a monitor. The photographer is able to view the photographed image through, for example, an LCD monitor (not shown) provided on a rear side of the camera. body 10.

Configuration of Optical Low Pass Filter 500

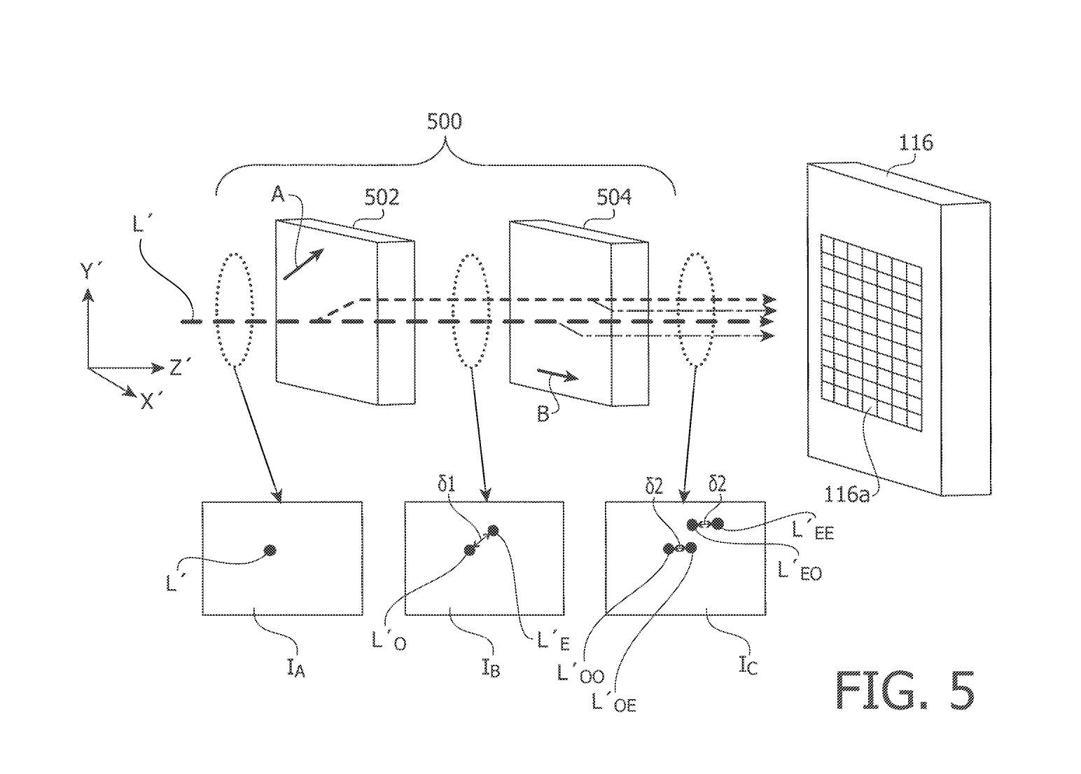

FIG. 5 schematically illustrates a configuration of the optical low pass filter 500. As shown in FIG. 5, the optical low pass filter 500 includes a first polarizing beam splitter 502 and a second polarizing beam splitter 504. In FIG. 5, a center axis (the optical axis of the imaging lens 202) of the imaging surface 116a of the image sensor 116 is defined as Z′-axis direction, two directions which are perpendicular to Z′-axis direction and are perpendicularly intersect with each other are defined as X′-axis direction (the width direction of the optical low pass filter 500) and Y′-axis direction (the height direction of the optical low pass filter 500).

In FIG. 5, the positional relationship between light rays in planes (X′Y′ plane) which are perpendicular to the direction in which the light ray L′ is incident is shown as illustrations I_{A}, I_{B}, and I_{C} for the positional relationship of light rays. The illustration I_{A} for positional relationship of light rays shows the positional relationship of light ray before entering to the first beam splitter 502, the illustration I_{B} for positional relationship of light rays shows the positional relationship of the right rays after passing through the first beam splitter 502 and before entering the second beam splitter 504, and the illustration I_{C} for positional relationship of light rays shows the positional relationship of the light rays after passing through the second beam splitter 504.

In FIG. 5, arrows A and B respectively represent the optical axes x of the first polarizing beam splitter 502 and the second polarizing beam splitter 504 projected onto X′Y′ planes, respectively. More specifically, the optical axis x of the first polarizing beam splitter 502 is in the X′Y′ plane, and is oriented to form an angle of 45′ with respect to each of X′-axis direction and r-axis direction when viewed along the entering direction of the light ray L′ (see the arrow A). On the other hand, the optical axis x of the second beam splitter 504 is in the X′Y′ plane, and is oriented to the X′-axis direction when viewed along the entering direction of the light ray L′ (see the arrow B).

As shown in the illustration I_{B} for positional relationship of light rays, the light ray L′ is split by the first polarizing beam splitter 502 into the ordinary ray L′_{O} and the extraordinary ray L′_{E} with a predetermined splitting width δ1. The splitting direction of the light ray L′ by the first polarizing beam splitter 502 forms an angle of 45° with respect to each of the X′-axis direction and the Y′-axis direction (see the arrow A). As shown in the illustration I_{C} for positional relationship of light rays, the ordinary ray L′_{O} is split by the second polarizing beam splitter 504 into the ordinary ray L′_{OO} and the extraordinary ray L′_{OE} with a predetermined splitting width δ2. As shown in the illustration I_{c} for positional relationship of light rays, the extraordinary ray L′_{E} is split by the second polarizing beam splitter 504 into the ordinary ray L′_{EO} and the extraordinary ray L′_{EF}, with the predetermined splitting width δ2. The splitting direction of the ordinary ray L′_{O} and the extraordinary ray L′_{E} by the second polarizing beam splitter 504 is the X′-axis direction (the direction of the arrow B). Thus, the ordinary ray L′ is split into four light rays (ordinary ray L′_{OO}, extraordinary ray L′_{OE}, ordinary ray L′_{EO} and extraordinary ray L′_{EE}) by passing through the optical low pass filter 500.

On the imaging surface 116a of the image sensor 116, a plurality of pixels are arranged in a matrix in the X′Y′ plane. The splitting width δ2 is equal to the pitch of the pixels arranged on the imaging surface 116a. Furthermore, the splitting width δ1 is √2 fold (≅1.141 fold) of the pixel pitch. For this reason, when a pixel on which the ordinary ray L′_{OO} is incident is defined as a reference pixel, the extraordinary ray L′_{OE} is incident on a pixel adjoining the reference pixel on the right-hand side, and the ordinary ray L′_{EO} is incident on a pixel adjoining the reference pixel on the upper right side. The extraordinary ray L′_{EE} is incident on a pixel adjoining, on the right-hand side, the pixel on which the ordinary ray L′_{EO} is incident. The light rays split by the optical low pass filter 500 are thus incident on different neighboring pixels, respectively, on the imaging surface 116a, and thereby occurrence of moire and a false signal can be suppressed.

Hereafter, an example of a method for adjusting the splitting width to a target (i.e., √2 fold of the pixel pitch) and adjusting the splitting width to a target (i.e., the pixel pitch) during design of the optical low pass filter is explained. The splitting width depends on the thickness t of the polarizing beam splitter 400 cut out from the polarizing optical element 300. Therefore, by appropriately setting the thickness t, the splitting widths δ1 and δ2 can be controlled.

Let us consider a case where the polarizing beam splitter 400 adapted for the image sensor 116 having the pixel pitch of 2.5 μm is cut out from the polarizing optical element 300 according to the 3^{rd} example. According to the above described expression for the splitting width δ, the thickness t of the polarizing beam splitter 400 to be cut out from the polarizing optical element 300 to obtain the splitting δ2=2.5 μm is 774 μm. According to the above described expression for the splitting width δ, the thickness t of the polarizing beam splitter 400 to be cut out from the polarizing optical element 300 to obtain the splitting width δ1=3.5 μm (≅2.5×√2) is 1094 μm. It should be noted that the splitting direction of the ordinary ray and the extraordinary ray can be changed by changing the direction of the optical axis x while maintaining the angle θ between the incident light L and the optical axis x of the polarizing beam splitter 400.

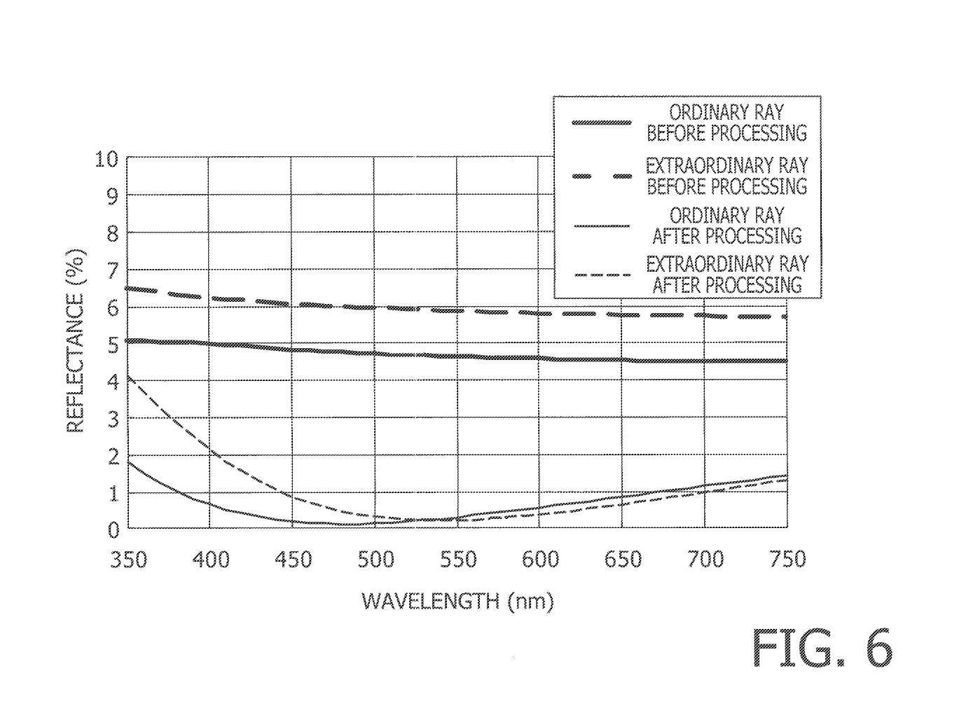

To each of the entrance surface and the exit surface of the first polarizing beam splitter 502 and the second polarizing beam splitter 504, a antireflection coating is applied. Here, an example where an antireflection coating is applied to each of the entrance surface and the exit surface of a flat plate having the thickness of 774 μm which is cut out as the second polarizing beam splitter 504 from the polarizing optical element 300 according to the 3^{rd} example is explained. In this example, plasma etching is applied to the polarizing beam splitter 504 for 900 seconds by using a plasma gun BS-80010 provided by JEOL Ltd. attached to a vacuum chamber. As an etching condition, argon gas of 12 sccm and oxygen gas of 20 sccm are provided at the electric discharge voltage of 110V and the filament current of 40 A. Through the plasma etching process, a region of polymethyl methacrylate of each of the entrance surface and the exit surface of the second polarizing beam splitter 504 is etched by approximately 0.1 μm, and thereby the etching surfaces shows the antireflection property formed of a diffraction structure at intervals of 0.4 μm. FIG. 6 is a graph illustrating the spectral reflectance of the entrance surface and the exit surface of the second polarizing beam splitter 504 before and after the plasma etching process. As shown in FIG. 6, by applying the antireflection processing, the reflectance of each of the entrance surface and the exit surface of the second polarizing beam splitter 504 is reduced.

Since the polarizing optical element 300 is a composite body of resin with the specific gravity of approximately 1.0 to 1.6, the polarizing optical element 300 is light in weight relative to an ordinary polarizing optical element made of crystal having the specific gravity of 2.65. Furthermore, since the polarizing optical element 300 is a laminated body of polymeric films, the polarizing optical element 300 has a high degree of flexibility and the cutting processing, the molding processing, the surface processing and so on can be easily applied thereto.

As described above, according to the embodiment, the polarizing optical element 300 and the optical low pass filter 500 which are inexpensive and easy to manufacture, and are adapted for increasing the area thereof are provided. Since the polarizing optical element 300 and the optical low pass filter 500 are light in weight, has a high degree of flexibility and is easy to bend, polarizing optical element 300 and the optical low pass filter 500 can be advantageously accommodated in the photographing apparatus and have the advantage that the surface processing and so on can be applied easily. Therefore, the optical low pass filter 500 is suitable for use as an optical low pass filter for a photographing apparatus.

The foregoing is the explanation about the embodiment of the invention. The invention is not limited to the above described embodiment, but can be varied in various ways within the scope of the invention. For example, the invention includes a combination of embodiments explicitly described in this specification and embodiments easily realized from the above described embodiment.

For example, in the above described embodiment, the antireflection processing by plasma etching is applied to the surface of the polarizing beam splitter; however, in another embodiment, vacuum evaporation may be applied to the surface of the polarizing beam splitter. Furthermore, on the surface of the polarizing beam splitter, an antistatic coating, such as, tin-doped indium oxide (ITO), aluminum-doped zinc oxide (AZO), gallium-doped zinc oxide (GZO), antimony-doped zinc oxide (ATO) or fluorine-doped tin oxide (Fro), or a water repellent or oil repellent film, such as, an organic silicon compound or an organic fluorine compound may be formed. Furthermore, in the antireflection processing by the plasma etching, a diffraction structure (e.g., the pitch of 0.2 μm to 200 μm) may be provided on the polarizing beam splitter by masking the surface of the polarizing beam splitter with metal so that the function as a diffractive optical element can be provided on the surface of the polarizing beam splitter.

In the above described embodiment, the polarizing optical element 300 is formed of the first polymeric films 302 and the second polymeric films 304; however, in another embodiment, the polarizing optical element 300 may be formed of more than two types of polymeric films. It should be noted that when the first polymeric films 302 and the second polymeric films 304 are bonded by an adhesion of the ultraviolet curable type having the difference in refractive index with respect to both of the first polymeric film 302 and the second polymeric film 304, the adhesion layer also constitutes a film layer.

This application claims priority of Japanese Patent Application No. P2013-098199, filed on May 8, 2013, The entire subject matter of the application is incorporated herein by reference.

What is claimed is:

1. A polarizing optical element comprising a multilayer film in which two or more types of polymeric films are laminated, wherein a number of laminated polymeric films is 500 to 500,000 in total, each of the two or more types of polymeric films has a uniform refractive index and has a film thickness of 0.2 μm to 40 μm, and a difference in refractive index between the two or more types of polymeric films is larger than or equal to 0.05.

2. The polarizing optical element according to claim 1, wherein:
the two or more types of polymeric films comprise a first polymeric film and a second polymeric film;
the first polymeric film has a refractive index of 1.56 to 2.5; and
the second polymeric film has a refractive index of 1.34 to 1.55.

3. The polarizing optical element according to claim 2,
wherein:
the first polymeric film is one of polyester, polycarbonate, and high refractive index ultraviolet curing resin; and
the second polymeric film is one of amorphous polyolefin, polymethyl methacrylate, fluororesin, and low refractive index ultraviolet curing resin.

4. The polarizing optical element according to claim 1, wherein a surface of the polarizing optical element is provided with one of an antireflection coating, an antistatic coating, a water repellent film, an oil repellent film and a diffraction structure.

5. An optical low pass filter comprising a polarizing beam splitter obtained as a flat plate member cut out from a polarizing optical element according to claim 1, wherein the flat plate member is cut out from the polarizing optical element to have a predetermined angle with respect to an optical axis of the polarizing optical element.

6. A photographing apparatus, comprising:
an imaging optical system;
an optical low pass filter according to claim 5, wherein the optical low pass filter splits a light ray passed through the imaging optical system into a plurality of light rays in a predetermined direction and at a predetermined splitting width; and
a solid state imaging device on which the plurality of light rays split by the optical low pass filter incident,
wherein the plurality of light rays split by the optical low pass filter are incident on different neighboring pixels arranged on the solid state imaging device.
